(19) United States
(12) Patent Application Publication
(10) Pub. No.: US 2006/0284586 A1
(43) Pub. Date: Dec. 21, 2006

(54) COMBINATION INSTRUMENT

(75) Inventors: Yngve HAGBERG, Goteborg (SE); Leif Olsson, Goteborg (SE)

Correspondence Address: NOVAK DRUCE & QUIGG, LLP, 1300 EYE STREET NW, 400 EAST TOWER, WASHINGTON, DC, 20005, US

(73) Assignee: VOLVO LASTVAGNAR AB, Goteborg (SE)

(21) Appl. No.: 11/160,345

(22) Filed: Jun. 20, 2005

Related U.S. Application Data
(63) Continuation of application No. PCT/SE03/01930, filed on Dec. 10, 2003.

(30) Foreign Application Priority Data
Dec. 10, 2002 (SE) 0203814-9

(51) Int. Cl. G05B 19/10

(52) U.S. Cl. 318/567

(57) ABSTRACT

Method and arrangement for providing a combination instrument (1) for a motor vehicle that includes a display (2) for giving messages to an operator, at least four separate switches (3) for receiving messages from an operator, a menu system (6) and a separate control output (8) for adjusting a seat steplessly. In addition, the invention relates to a system having a combination instrument and an adjustable seat and a method for adjusting a seat using a combination instrument.

### CROSS-REFERENCE TO RELATED APPLICATIONS

The present application is a continuation patent application of International Application No. PCT/SE2003/01930 filed 10 Dec. 2003 which was published in English pursuant to Article 21(2) of the Patent Cooperation Treaty, and which claims priority to Swedish Application No. 0203814-9 filed 20 Dec. 2002. Said applications are expressly incorporated herein by reference in their entireties.

### FIELD OF THE INVENTION

The present invention relates to a combination instrument with integrated control of a seat and a method for controlling a seat.

### BACKGROUND ART

In modern vehicles there are many functions that are controlled electrically. Some of these functions are of the on/off type and require no other control than a simple switch; for example certain lamps. Some functions, on the other hand, can be configured in several stages and/or are programmed in different ways; for example windshield wipers. The control of these functions is carried out by some form of switch with several positions or by a separate control unit where control and programming is carried out. Usually the switch is of the low-current type connected to a power unit, for example a relay, which can handle the required current.

A function that often has many adjustments and which is often fitted, in particular on vehicles for commercial traffic, is an adjustable driver's seat. Seats are usually adjustable either electrically or pneumatically. The adjustment of a seat is carried out using a number of switches or valve arrangements that are usually located on the outer side of the seat cushion and/or the back support. The location and function of these switches or valve arrangements differ between different types of vehicles and different makes of seats.

As vehicle seats, particularly for heavy vehicles, are purchased ready-made from sub-suppliers, vehicle manufacturers are predominantly unable to influence the location and design of the operating controls for the seat. This means that a vehicle supplier can sell the same type of vehicle with several different seats and accordingly different ways of adjusting the seats.

EP 0158507 AI describes an arrangement for adjusting a seat in a car. The arrangement consists of a separate unit with a number of dedicated switches and a dedicated display that is designed to show the current setting of the seat at all times.

EP 0816155 A3 describes an arrangement for adjusting a seat in a car. The arrangement consists of a display screen in which a pointer is moved steplessly between different symbols on the screen. When a symbol has been marked (i.e., when the symbol has been selected), the pointer is then moved between different functions associated with the symbol. Each selection and setting requires the pointer to be moved on the screen with a stepless pointing device.

U.S. Pat. No. 4,808,897 describes an arrangement for adjusting a seat in a car. The arrangement consists of a separate unit with a number of dedicated switches, where a switch steps in turn between the different functions that can be selected, and with a dedicated display, designed only to show the current setting of the seat.

Although these arrangements can work in certain situations, they have a number of disadvantages.

Firstly, the user interface of the arrangement differs from the user interface for most other functions in the vehicle. This means that the user interface is not easy to understand and is not intuitive.

Secondly, the arrangements described take up space unnecessarily on the dashboard, where they are located in an area close to the steering wheel that is easily accessible, as they are dedicated units intended only for adjusting a seat. This area around the steering wheel is currently already overloaded with switches which makes it difficult to locate the unit in an easily-accessible place.

Thirdly, a separate control unit is unnecessarily expensive.

Fourthly, a separate control unit is inflexible. For passenger cars, this perhaps does not matter, as they are supplied with one type of seat, but for a heavy vehicle that can be supplied with a number of different seats with varying functionalities, it is inconvenient and expensive to have a plurality of different control units.

Fifthly, a separate control unit often does not fit in with the design of the vehicle.

Sixthly, it is unnecessarily complicated to upgrade the software in a separate control unit.

### DISCLOSURE OF INVENTION

An object of the invention is therefore to obtain a combination instrument that makes it possible to adjust a seat in a simple and inexpensive way, and a method for controlling a seat in a simple way by means of a combination instrument.

The solution to this problem according to the present invention relates to a combination instrument for a motor vehicle, comprising (including, but not necessarily limited thereto) a display to provide messages to an operator, an input unit for receiving messages from an operator, a databus for communication with existing control units in the vehicle and a menu system. The solution to the problem, according to the invention, is achieved by the combination instrument comprising a separate control output for adjusting at least one parameter for a seat.

The method according to the invention solves the problem by means of the steps of selecting in a menu system the function for seat adjustment by means of a first switch, of displaying a graphical representation of the seat on a display integrated in the combination instrument, of changing at least one parameter for the seat in the said function by means of a second and/or third switch and of concluding the function after the change has been carried out by means of a fourth switch.

By means of this first embodiment of the combination instrument according to the invention, it is possible to adjust a seat steplessly by means of the combination instrument. The advantage of this is that it is possible to adjust a vehicle seat without the seat needing to have separate operating controls.

In an advantageous first further development of the combination instrument according to the invention, it is possible to save and retrieve settings that have been carried out using the combination instrument. The advantage of this is that different drivers can quickly and easily obtain their personal settings for the seat.

In an advantageous second further development of the combination instrument according to the invention, the combination instrument comprises a function for associating a stored value with an identification code. The advantage of this is that a seat can be adjusted automatically to the settings for the driver in question.

The method according to the invention makes it possible to adjust steplessly at least one parameter for a seat by means of the existing menu system in the combination instrument. The advantage of this method is that the user interface that is used for the vehicle's other functions can also be used for adjusting the seat.

### BRIEF DESCRIPTION OF DRAWINGS

The invention will be described in greater detail in the following, with reference to embodiments that are shown in the accompanying drawings, and in which:

FIG. 1 is a schematic representation of an existing combination instrument;

FIG. 2 is a schematic representation of a combination instrument according to the invention; and

FIG. 3 shows an example of a selected seat menu in a combination instrument according to the teachings of the present invention.

### DETAILED DESCRIPTION

The embodiments of the invention described in the following with further developments are to be regarded only as examples, and are in no way limiting to the protection provided by the claims. In the embodiments described herein, the same reference numerals in the different figures refer to the same type of component. Each component is therefore not described in detail in all the embodiments.

In the following examples, a vehicle seat is used where adjustment is carried out by electrical signals, as an example of a steplessly-adjustable seat. It is, however, to be understood that all types of seat adjustment are included in which control of the adjustment of the seat is carried out electrically, for example an electrically-controllable pneumatic seat.

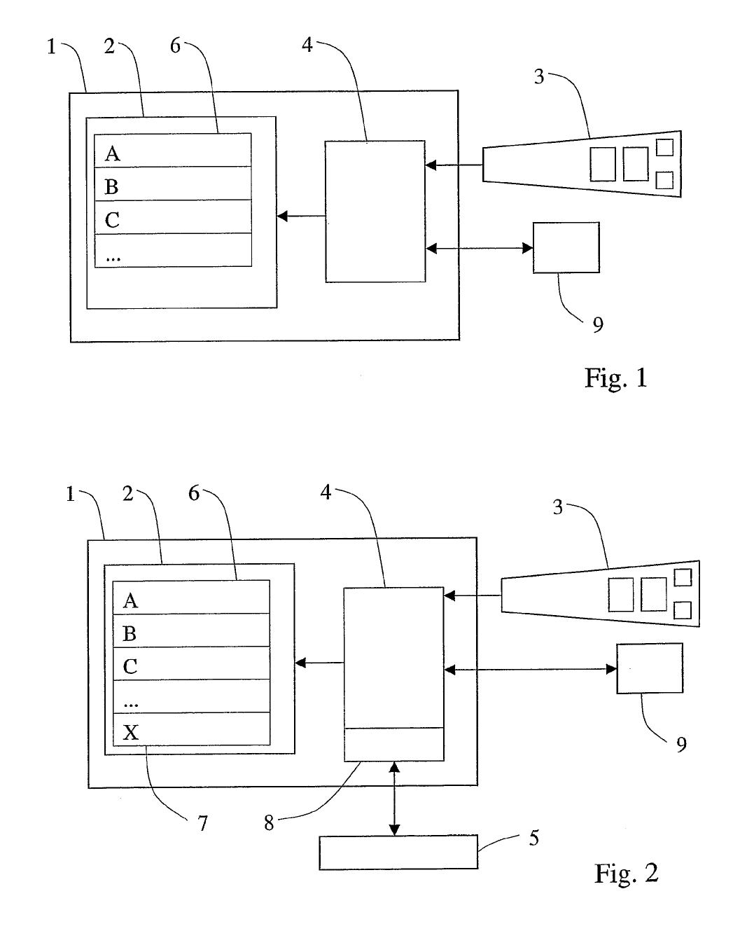

FIG. 1 shows an existing combination instrument 1 comprising a display 2 and a control unit 4 integrated in the combination instrument. A combination instrument is a unit on a vehicle where information that relates to the vehicle and the driving of the vehicle is displayed. A typical combination instrument for a heavy vehicle comprises pointer instruments that display such things as, for example, the vehicle speed, engine speed, brake pressure, engine temperature, and the like, as well as various control lamps, for example indicators, full-beam headlights, and the like, in addition to a trip computer. The combination instrument is connected to other control units on the vehicle by a databus.

An input unit with a keypad 3 is connected to the control unit 4. The display 2 is used to display information of various types, for example status messages, error messages and time. It is also used to make settings via a menu system 5 with different menus. The control unit 4 contains software and logic circuits that control the instrument. The control unit 4 also receives information from the vehicle's other control units 9 via a databus on which information from the combination instrument is also transmitted. As exemplified herein, the keypad 3 consists of four switches that are used to navigate the menu system. The switches represent the functions “Enter”, “Escape”, “Up” and “Down”. The keypad 3 is located on the vehicle's windshield wiper arm.

To select a function in the menu system, the switches “Up” and “Down” are used to find the desired menu. This menu is then selected using “Enter.” For each menu there can be several submenus where various settings and selections can be made. For example the time can be set or the operator can see the calculated remaining driving distance. When this has been carried out, the operator goes back to the preceding menu using “Escape”.

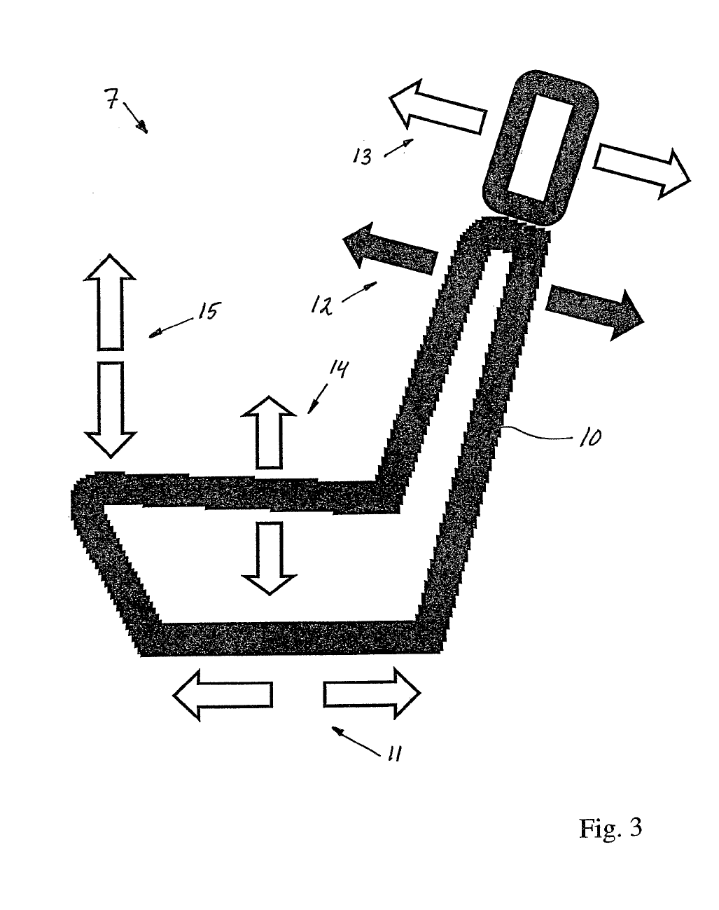

FIG. 2 shows a first embodiment of a combination instrument according to the invention. Here, the menu system 6 has been augmented by a seat menu 7. The control unit 4 has been augmented by a control output S that directly controls the seat 5. The control output 8 is matched to the connected seat 5. The control output 8 is advantageously a mechanical interface that is standardized so that the same connection can be used for different models of seat. The control output 8 can be based on a databus with suitable protocol. When there is a need to read data from the seat, the control output 8 is bi-directional. It is, of course, also possible for the control output 8 to consist of a number of analogue and/or digital outputs and inputs that control different functions in the seat in a known way, either by means of low-level signals or by means of signals that control, for example, motors and valves directly. The seat menu 7 is selected in the menu system in the same way as previously described.

A number of settings can be carried out in the seat menu 7, for example adjustment of the most common functions for the seat 5, for example raising or lowering the seat and moving the seat forwards or backwards. Additionally, one or more submenus can be selected for functions that are used less frequently, for example, adjustment of a lumbar support. In the seat menu 7, the values of different settings can be read off, for example the angle of the seat back and whether an end position for any function has been reached when the seat incorporates sensors that can detect this.

The input for the adjustment of the seat can also be carried out by other means than a keypad 3. For example, it is possible to have a wireless remote control or for the keypad 3 to be mounted on the steering wheel. In certain situations, it can be advantageous to use voice control to carry out the adjustment of the seat. The voice control can work in the same way as the keypad; that is, the menu is controlled in the same way by navigation using “Up” and “Down” and selecting functions. The selected function is displayed by symbols on the display. The advantage of this is that the voice recognition is simple as the system does not need to learn all the possible names for the various seat adjustments. In this case, it is sufficient for it to recognize the commands for the functions that the switches represent. This makes it easy to adapt the voice control for different countries or markets. It is, of course, also possible to utilize voice control that understands all the commands directly.

FIG. 3 shows an example of a seat menu 7. When the seat menu 7 is selected, a graphical image 10 of the seat 5 is displayed. The required function is selected by navigating through the functions. In this example, symbols are displayed for depth adjustment 11, height adjustment 15, adjustment of the height of the seat cushion 14, adjustment of the angle of the back support 12 and adjustment of the angle of the headrest 13. The symbol for the function that is active is indicated in the image by this symbol being marked in a special way, for example by changing or inverting the color of the symbol. When the function is selected, this can also be marked in some way. In this example, an active function is indicated by its symbol flashing, and when the function is selected the color of the symbol is inverted. In FIG. 3, the symbol for the angle of the back support 12 has been selected. This is shown by the color of these arrows being inverted. The angle of the back support is adjusted by the switches for “Up” and “Down”. When the setting of a function is completed, the operator goes back to the navigation mode using “Escape.” The set value is saved as the current value. For certain functions, it can be advantageous to confirm a setting specially using “Enter”, for example when seat heating is adjusted. Certain functions that are not used so frequently can be adjusted in a submenu which is selected in the same way. For example, the various settings for the lumbar support can be carried out in a submenu. This can be advantageous in order to keep a menu uncluttered and so that there are not too many adjustable functions in one menu. When the required settings have been carried out, the operator returns to the main menu.

In the seat menu 7, the current settings can also be stored in a memory (not shown), with the memory being able to be associated with a particular person. The settings in a menu can also be retrieved in the menu system.

The link between a person and the values stored in a memory can be made in several different ways. One possibility is that the operator selects in a menu which memory setting he/she wants to retrieve. Another possibility is that it is carried out automatically when the operator identifies himself to the vehicle, for example using a smart card.

When the operator is adjusting the seat, he/she is sitting in the same position as when he/she is driving the vehicle. This means that the operator can immediately feel when the seat is in the desired position without the need to twist or turn. This ensures that the driver is in an optimal sitting position.

In the seat menu, not only can the seat's parameters be adjusted steplessly, but it is also possible to switch functions on or off, for example the seat heating can be switched on or off. The seat heating can also be adjusted in several discrete steps or steplessly, depending upon the seat model. It can also be possible to read off the temperature of the seat cushion in a menu. Programming of certain seat functions is also possible, for example so that the seat heating is to be switched on each time the vehicle is started up, only the first time the vehicle is started up during a driving shift or only when the external temperature is below a certain temperature.

In a second embodiment of the combination instrument 1 of the present invention, it is also possible to adjust a passenger seat using the instrument. Depending upon the type of seat, this can be carried out in various ways. For a simple type of seat, where, for example, only adjustment forwards and backwards is possible, this adjustment can be carried out directly from the instrument. This can, for example, be the case in a vehicle with a so-called “office package” where the seat is to be folded away when the bed is to be used.

When a passenger seat that has several adjustment options is to be adjusted, this can be carried out in several ways. When the combination instrument is equipped with voice control, the passenger can also use this. In this case, the setting of the passenger seat is selected in a menu. Thereafter, e passenger adjusts the seat as required. In the case when the voice control works in the same way as the keypad and when the display is difficult to see from the passenger seat, it is possible for the combination instrument also to provide acoustic information about which function is active. This can also be advantageous if the passenger seat is being adjusted by remote control.

When the passenger seat is to be adjusted by means of a keypad in the vicinity of the combination instrument, the passenger can sit in the driver's seat and adjust the seat as required. Thereafter these settings can be transferred to the passenger seat, after which the driver's seat returns to the previous settings. This saves having extra switches on the passenger seat and. makes it possible for the same seat to be used for the driver's side and the passenger's side. In addition, the passenger's settings can be stored and retrieved from one or more memory locations.

In a first embodiment of the method of the invention, a seat is adjusted by a control system integrated in a combination instrument. In order to adjust the seat, the seat menu is first selected in the menu system. This is carried out in the traditional way using a keypad containing a number of switches. Here the keypad contains four switches. This keypad can advantageously be located on any arm or lever already in the vehicle, for example the windshield wiper arm. The required settings for the seat are thereafter carried out in the seat menu. The switches correspond to the functions “Up”, “Down”, “Escape” and “Enter.”

When the seat menu is selected using “Enter,” a graphical image of the seat is displayed. The required function is selected by navigating through the functions using “Up” and “Down.” The function that is active is indicated in the image by this part of the seat being marked in a special way, for example by changing or inverting the color of this part of the image. When a function is active, this function can be selected using “Enter.” When a function is selected, this function can be adjusted with the switches for “Up” and “Down.” Certain functions that are not used as frequently can be adjusted in a submenu that is selected in the same way. When the required settings have been carried out, the operator returns to the main menu using “Escape.”

A computer program according to the invention comprises a program code for steplessly adjusting at least one seat, by means of a control system integrated in a combination instrument, when the program is executed by a processor integrated in the combination instrument.

The computer program, according to the invention, can be stored on a medium that can be read by a computer system integrated in the combination instrument. This medium can be, for example, a data diskette, a memory module, a CD or the like. This can be advantageous, for example when the program is to be downloaded into the vehicle during production and/or when the program in the vehicle is to be updated. The updating of the software can take place, for example, at regular services or, if so required, directly by a customer. The updating of software can also be carried out via a connection, for example via the Internet, to a server where the program is stored.

The invention is not to be regarded as being limited to the embodiments described above, a number of additional variants and modifications being possible within the framework of the following claims. For example, the input to the combination instrument can also be carried out in other ways and, in addition, the combination instrument's information can be shown on a display outside the combination instrument.

What is claimed is:

1. A combination instrument (1) for a motor vehicle, said combination instrument (1) comprising:
a display (2) for giving messages to an operator, an input unit (3) for receiving messages from an operator, a databus for communication with control units (9) already in the vehicle and a menu system (6) integrated in the combination instrument; and
said combination instrument (1) further comprising a separate control output (8) for steplessly adjusting at least one parameter for at least one seat (5) and wherein the input unit (3) comprises at least four separate switches.

2. The combination instrument as recited in claim 1, wherein the combination instrument (1) includes a function for selecting, from a plurality of subfunctions for said at least one seat (5).

3. The combination instrument as recited in claim 1, wherein the combination instrument (1) includes a means for selecting, from a plurality of subfunctions, a function for said at least one seat (5).

4. The combination instrument as recited in claim 1, wherein the combination instrument (1) comprises a function for storing and retrieving at least one set value for said at least one seat (5).

5. The combination instrument as recited in claim 4, wherein the combination instrument (1) comprises a function for associating the at least one stored value with an identification code.

6. The combination instrument as recited in claim 4, wherein the combination instrument (1) comprises a means for associating the at least one stored value with an identification code.

7. A system in an motor vehicle for adjusting a seat in the vehicle, said system comprising:
an adjustable seat (5) and a combination instrument comprising:
a display (2) for giving messages to an operator, an input unit (3) for receiving messages from an operator, a databus for communication with control units (9) already in the vehicle and a menu system (6) integrated in the combination instrument; and
said combination instrument (1) further comprising a separate control output (8) for steplessly adjusting at least one parameter for at least one seat (5) and wherein the input unit (3) comprises at least four separate switches.

8. The system as recited in claim 7, wherein the input unit (3) is located on a steering wheel console of the vehicle.

9. The system as recited in claim 7, wherein the input unit is located on a windshield wiper arm.

10. The system as recited in claim 7, wherein the input unit is located on an indicator arm.

11. A method for steplessly adjusting at least one parameter for a seat using a control system integrated in a combination instrument, said combination instrument comprising a separate control output and a menu system, said method comprises the steps of:
selecting in the menu system the function for seat adjustment by means of a first switch;
displaying a graphical representation of the seat on a display integrated into the combination instrument;
changing at least one parameter for the seat in the function by means of one of a second and a third switch; and
concluding the function by means of a fourth switch after the change has been made.

12. A method as recited in claim 11, wherein the method further comprises a step of selecting one of a plurality of subfunctions for the seat.

13. A method as recited in claim 11, wherein the method further comprises a step of at least one of storing and retrieving at least one set value for the seat.

14. A computer program comprising program code for executing the following method when said program is executed by a computer, said method being for steplessly adjusting at least one parameter for a seat using a control system integrated in a combination instrument, said combination instrument comprising a separate control output and a menu system, said method comprises the steps of:
selecting in the menu system the function for seat adjustment by means of a first switch;
displaying a graphical representation of the seat on a display integrated into the combination instrument;
changing at least one parameter for the seat in the function by means of one of a second and a third switch; and
concluding the function by means of a fourth switch after the change has been made.

15. A computer program product comprising program code stored on a medium that can be read by a computer for carrying out the following method when the program is executed by a computer, said method being for steplessly adjusting at least one parameter for a seat using a control system integrated in a combination instrument, said combination instrument comprising a separate control output and a menu system, said method comprises the steps of:
selecting in the menu system the function for seat adjustment by means of a first switch;
displaying a graphical representation of the seat on a display integrated into the combination instrument;
changing at least one parameter for the seat in the function by means of one of a second and a third switch; and
concluding the function by means of a fourth switch after the change has been made.
